(19) United States
(12) Patent Application Publication
(10) Pub. No.: US 2025/0363378 A1
(43) Pub. Date: Nov. 27, 2025

(54) METHOD AND SYSTEM FOR MANAGING POSITION INFORMATION, AND COMPUTER READABLE STORAGE MEDIUM

(71) Applicant: HTC Corporation, Taoyuan City (TW)

(72) Inventor: Kuo-Hsiu Lee, Taoyuan City (TW)

(73) Assignee: HTC Corporation, Taoyuan City (TW)

(21) Appl. No.: 18/671,956

(22) Filed: May 22, 2024

(51) Int. Cl. G06N 3/092; G06T 13/40; H04W 4/029

(52) U.S. Cl. CPC G06N 3/092; G06T 13/40; H04W 4/029

(57) ABSTRACT

The embodiments of the disclosure provide a method and system for managing position information, and a computer readable storage medium. The method includes: receiving, by a server, first position information from a first client device; determining, by the server, whether to provide the first position information to a second client device by using a machine learning model; in response to determining to provide the first position information to the second client device, sending the first position information to the second client device; and in response to determining that a feedback message corresponding to the first position information has been received from the second client device, updating, by the server, the machine learning model according to the feedback message.

### BACKGROUND

### 1. Field of the Invention

The present disclosure generally relates to a mechanism for managing information, in particular, to a method and system for managing position information, and a computer readable storage medium.

### 2. Description of Related Art

When a large number of users enter the same virtual space (e.g., a virtual reality (VR) world), there's a need for constant exchange of substantial amounts of user position data. This volume of data can directly impact the performance of both servers and users' client devices, causing decreased operational speeds and potentially introducing latency issues.

### SUMMARY OF THE INVENTION

Accordingly, the disclosure is directed to a method and system for managing position information, and a computer readable storage medium, which may be used to solve the above technical problems.

The embodiments of the disclosure provide a method for managing position information. The method includes: receiving, by a server, first position information from a first client device; determining, by the server, whether to provide the first position information to a second client device by using a machine learning model; in response to determining to provide the first position information to the second client device, sending the first position information to the second client device; and in response to determining that a feedback message corresponding to the first position information has been received from the second client device, updating, by the server, the machine learning model according to the feedback message.

The embodiments of the disclosure provide a system for managing position information, comprising a server. The server is configured to perform: receiving first position information from a first client device; determining whether to provide the first position information to a second client device by using a machine learning model; in response to determining to provide the first position information to the second client device, sending the first position information to the second client device; and in response to determining that a feedback message corresponding to the first position information has been received from the second client device, updating the machine learning model according to the feedback message.

The embodiments of the disclosure provide a computer readable storage medium, the computer readable storage medium recording an executable computer program, the executable computer program being loaded by a server to perform steps of: receiving first position information from a first client device; determining whether to provide the first position information to a second client device by using a machine learning model; in response to determining to provide the first position information to the second client device, sending the first position information to the second client device; and in response to determining that a feedback message corresponding to the first position information has been received from the second client device, updating the machine learning model according to the feedback message.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the disclosure.

FIG. 1 shows a schematic diagram of the system for managing position information according to an embodiment of the disclosure.

FIG. 2 shows a flow chart of the method for managing position information according to an embodiment of the disclosure.

FIG. 3 shows a flow chart of the operations of the second client device in response to the first position information according to an embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

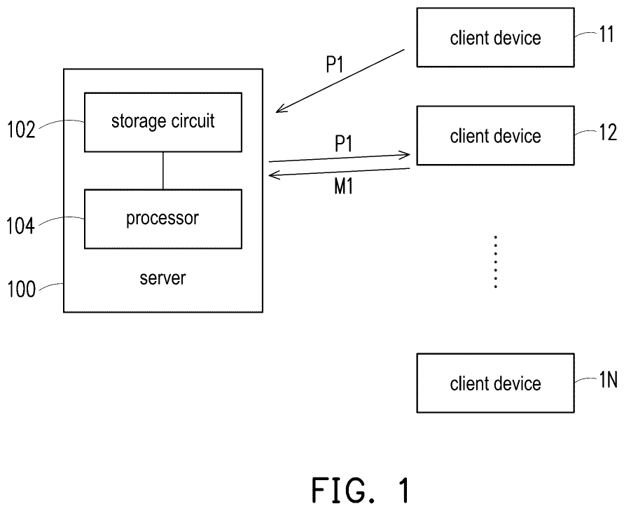

See FIG. 1, which shows a schematic diagram of the system for managing position information according to an embodiment of the disclosure.

In the embodiment, the system 10 includes a server 100 and client devices 11-1N (where N is a positive integer larger than 1). In various embodiments, the server 100 and/or the client devices 11-1N can be any smart device/computer device. In other embodiments, the mechanism introduced in the disclosure may also be carried out by multiple servers, but the disclosure is not limited thereto.

In some embodiments, the client devices 11-1N can be host devices (e.g., head-mounted displays (HMDs)) capable of providing visual contents of reality services for the corresponding user to see, but the disclosure is not limited thereto. In some embodiments, the reality services may be augmented reality (AR) service, VR service, mixed reality (MR) service, extended reality (ER) service, and the corresponding visual contents may be AR/VR/MR/ER contents, but the disclosure is not limited thereto.

In the embodiment, the server 100 includes a storage circuit 102 and a processor 104. The storage circuit 102 is one or a combination of a stationary or mobile random access memory (RAM), read-only memory (ROM), flash memory, hard disk, or any other similar device, and which records a plurality of modules and/or a program code that can be executed by the processor 104.

The processor 104 may be coupled with the storage circuit 102, and the processor 104 may be, for example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like.

In some embodiments, each client device 11-1N may have the same structure of the server 100, but the disclosure is not limited thereto.

In the embodiments of the disclosure, the client devices 11-1N may exchange the respective position information via the server 100. For example, when the client device 11 has determined the position information P1 (e.g., the coordinates and/or orientation) thereof by tracking mechanisms (e.g., inside-out tracking and/or outside-in tracking) in at least one environment where the client device 11-1N locate (e.g., the client devices 11-1N may be in the same environment or distributed in different environments), the client device 11 may send the position information P1 to the server 100, and the server 100 may send the position information P1 to, for example, the client device 12 and/or other client devices, but the disclosure is not limited thereto.

In one embodiment, after the client device 12 receives the position information P1, the client device 12 may accordingly perform the associated subsequent operations.

For better understanding, the client devices 11 to 1N would be assumed to be immersing in the same virtual world (e.g., the same VR world) within the same environment (e.g., a field, room, or other similar spaces). In this case, what one client device renders as the provided visual content (e.g., VR contents) may be associated with another client device.

For example, if the position where the client device 11 locates in the environment is in front of the client device 12 (e.g., the client device 11 is in the field of view (FOV) of the client device 12), the rendered visual content of the client device 12 may need to, for example, show the avatar corresponding to the client device 11.

For another example, if the position where the client device 12 locates in the environment is behind the client device 11 (e.g., the client device 12 is not in the FOV of the client device 11), the rendered visual content of the client device 11 may not need to, for example, show the avatar corresponding to the client device 12.

In addition, if there exists an obstacle between the client device 11 and 12, such that the client device 11 is not in the FOV of the client device 12 (e.g., the client device 11 is occluded to the client device 12), the rendered visual content of the client device 12 may not need to, for example, show the avatar corresponding to the client device 11, but the disclosure is not limited thereto.

However, in the conventional way, although the client device 11 (and/or the associated avatar) may not be needed to be rendered in the visual content of the client device 12 in some scenarios (i.e., the client device 12 does not need the position information P1), the server 100 would still provide the position information P1 to the client device 12, which introduces unnecessary data transmissions.

Likewise, in the situations where other client devices do not need the position information P1, more unnecessary data transmissions would be introduced.

Accordingly, the embodiments of the disclosure have provided a solution for resolving the above problem, which would be introduced in the following.

In the embodiments of the disclosure, the processor 104 may access the modules and/or the program code stored in the storage circuit 102 to implement the method for managing position information provided in the disclosure, which would be further discussed in the following.

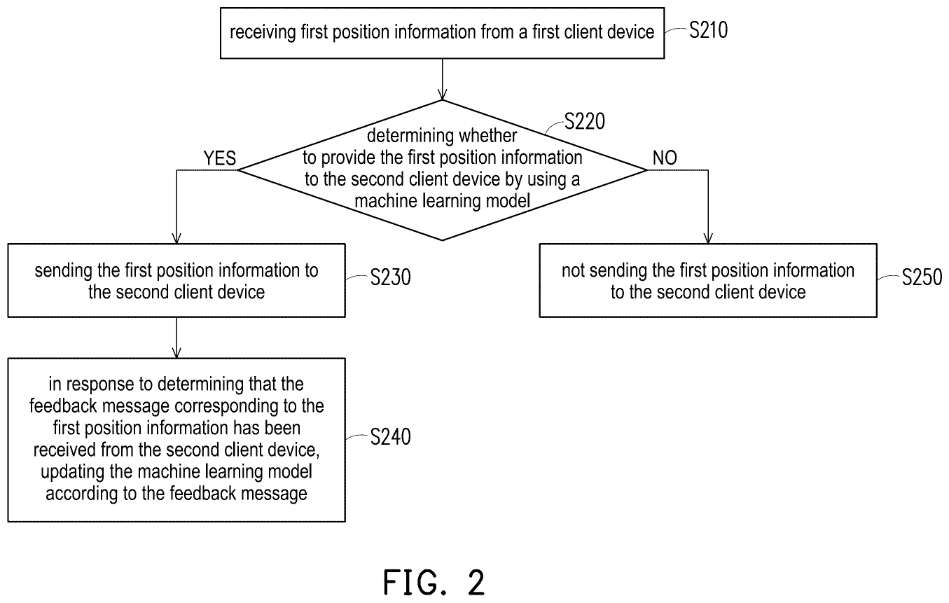

See FIG. 2, which shows a flow chart of the method for managing position information according to an embodiment of the disclosure. The method of this embodiment may be executed by the server 100 in FIG. 1, and the details of each step in FIG. 2 will be described below with the components shown in FIG. 1.

In step S210, the processor 104 receives first position information from a first client device. In step S220, the processor 104 determines whether to provide the first position information to a second client device by using a machine learning model.

For better understanding, the first client device and the second client device considered in the following discussions would be assumed to be, but not limited to, the client devices 11 and 12, respectively. Under this assumption, the first position information may be the position information P1, but the disclosure is not limited thereto.

That is, instead of directly providing the position information P1 to the client device 12, the processor 104 can determine whether to provide the position information P1 to the client device 12 by using a machine learning model.

In the embodiments of the disclosure, the machine learning model may be, for example, a reinforcement learning model that can be updated/trained based on the feedback messages from one or more of the client devices 11-1N.

In one embodiment, if the processor 104 determines that a feedback message from a certain client device (e.g., the client device 12) is a positive feedback message, it may represent that the determination made by the machine learning model may be acceptable to the certain client device. In this case, the processor 104 may update the machine learning model subject to a behavioural enforcement. That is, since the determination made by the machine learning model is acceptable to the certain client device, the processor 104 may update the machine learning model to enforce this behaviour, but the disclosure is not limited thereto.

In some embodiments, the positive message can also be understood as a reward message, but the disclosure is not limited thereto.

On the other hand, if the processor 104 determines that the feedback message from the certain client device is a negative feedback message, it may represent that the determination made by the machine learning model may be unacceptable to the certain client device. In this case, the processor 104 may update the machine learning model, but the disclosure is not limited thereto.

In some embodiments, the negative feedback message can also be understood as a punishment message, but the disclosure is not limited thereto.

In one embodiment, during step S220, the processor 104 may obtaining environmental information associated with the environment where the client devices 11 and 12 currently locate. In the embodiment, the environmental information may at least include devices poses (e.g., coordinates and/or orientations) of the client devices 11 and 12 (and/or other client devices), avatars corresponding to the first client device and the second client device, and/or configurations of environmental objects (e.g., appearances/sizes/positions of virtual objects in the virtual world and/or real objects in the environment) within the environment, but the disclosure is not limited thereto.

In some embodiments, the environmental information may be understood as scene information associated with the (virtual) scene where the client devices 11 and 12 (and/or other client devices) are immersing, and this scene information may include the information (e.g., appearances/sizes/positions) of the objects in the scene, but the disclosure is not limited thereto.

After obtaining the environmental information, the processor 104 may input the environmental information to the machine learning model, wherein the machine learning model may provide a determination result indicating whether to provide the position information P1 to the client device 12 in response to the environmental information.

That is, the machine learning model may determine whether to provide the position information P1 to the client device 12 based on the environmental information.

In one embodiment, in response to determining to provide the first position information (e.g., the position information P1) to the second client device, the processor 104 may perform step S230 to send the first position information to the second client device.

For example, if the determination result of the machine learning model indicates to provide the position information P1 to the client device 12, the processor 104 may accordingly send the position information P1 to the client device 12.

On the other hand, in response to determining not to provide the first position information (e.g., the position information P1) to the second client device, the processor 104 may perform step S250 to not send the first position information to the second client device.

For example, if the determination result of the machine learning model indicates not to provide the position information P1 to the client device 12, the processor 104 may accordingly not send the position information P1 to the client device 12, but the disclosure is not limited thereto.

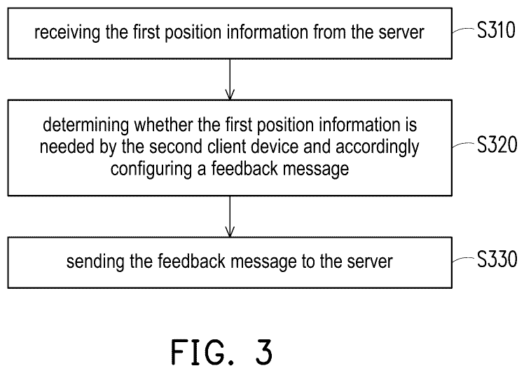

See FIG. 3, which shows a flow chart of the operations of the second client device in response to the first position information according to an embodiment of the disclosure.

In step S310, the second client device (e.g., the client device 12) receives the first position information (e.g., the position information P1) from the server 100.

In step S320, the second client device determines whether the first position information is needed by the second client device and accordingly configures a feedback message M1.

In one embodiment, the second client device may determine whether the first position information is needed by the second client device. In response to determining that the first position information is needed by the second client device, the second client device may configure the feedback message M1 as the positive feedback message. On the other hand, in response to determining that the first position information is not needed by the second client device, the second client device may configure, the feedback message M1 as the negative feedback message.

In step S330, the second client device sends the feedback message M1 to the server 100.

In one embodiment, the second client device may perform the determination in step S320 via determining whether an avatar corresponding to the first client device (e.g., the client device 11) is needed to be rendered in a visual content of the second client device based on the first position information.

For example, the second client device may perform a culling algorithm based on the first position information. In various embodiments, the culling algorithm may include one or more of occlusion culling, frustum culling, and other culling algorithm to determine whether the avatar corresponding to the first client device is visible to the second client device, but the disclosure is not limited thereto.

In one embodiment, in response to determining that a determination result of the culling algorithm indicates that the avatar corresponding to the first client device is not occluded to the second client device, it may represent that the avatar corresponding to the first client device may be visible to the user of the second client device during this user experiencing the virtual world. In this case, the second client device may determine that the avatar corresponding to the first client device is needed to be rendered in the visual content of the second client device.

On the other hand, in response to determining that a determination result of the culling algorithm indicates that the avatar corresponding to the first client device is occluded to the second client device, it may represent that the avatar corresponding to the first client device may not be visible to the user of the second client device during this user experiencing the virtual world. In this case, the second client device may determine that the avatar corresponding to the first client device is not needed to be rendered in the visual content of the second client device, but the disclosure is not limited thereto.

Details of the culling algorithm may be referred to the associated documents, which would not be provided herein.

In one embodiment, in response to determining that the avatar corresponding to the first client device is needed to be rendered in the visual content of the second client device, the second client device may determine that the first position information is needed by the second client device, and the second client device may send the feedback message M1 as the positive feedback message. On the other hand, in response to determining that the avatar corresponding to the first client device is not needed to be rendered in the visual content of the second client device, the second client device may determine that the first position information is not needed by the second client device, and the second client device may send the feedback message M1 as the negative feedback message, but the disclosure is not limited thereto.

In one embodiment, after the second client device has performed step S330, the processor 104 may accordingly perform step S240 in FIG. 2.

Referring back to FIG. 2, in step S240, in response to determining that the feedback message M1 corresponding to the first position information (e.g., the position information P1) has been received from the second client device (e.g., the client device 12), the processor 104 updates the machine learning model according to the feedback message M1.

In one embodiment, in response to determining that the feedback message M1 is the positive feedback message, the processor 104 may update the machine learning model to enforce this behaviour.

More specifically, since the positive feedback message may be understood as that the second client device actually needs the first position information (i.e., the machine learning model made a correct decision), the processor 104 may update the machine learning model to enforce this behaviour, but the disclosure is not limited thereto.

On the other hand, in response to determining that the feedback message M1 is the negative feedback message, the processor 104 may train the machine learning model based on the negative feedback message and the above environmental information.

More specifically, since the negative feedback message may be understood as that the second client device does not need the first position information (i.e., the machine learning model made a wrong decision), the processor 104 may use the above environmental information as the training data for the machine learning model. In this case, the machine learning model can be trained to learn that it is unnecessary to provide the position information P1 of the client device 11 to the client device 12 when the environmental information indicates some particular information of the environment.

Accordingly, the updated machine learning model can make the decisions about whether to provide the position information of one of the client devices 11-1N to another of the client devices 11-1N in a more proper/intelligent way, but the disclosure is not limited thereto.

The disclosure further provides a computer readable storage medium for executing the method for managing position information. The computer readable storage medium is composed of a plurality of program instructions (for example, a setting program instruction and a deployment program instruction) embodied therein. These program instructions can be loaded into the server 100 and executed by the same to execute the method for managing position information and the functions of the server 100 described above.

In summary, the embodiments of the disclosure provide a solution that the server can determine whether to provide the position information of one client device to another client device by using a machine learning model. Accordingly, some unnecessary data transmissions can be avoided, and hence the performance and efficiency of the whole system can be improved.

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

What is claimed is:

1. A method for managing position information, comprising:
receiving, by a server, first position information from a first client device;
determining, by the server, whether to provide the first position information to a second client device by using a machine learning model;
in response to determining to provide the first position information to the second client device, sending the first position information to the second client device; and
in response to determining that a feedback message corresponding to the first position information has been received from the second client device, updating, by the server, the machine learning model according to the feedback message.

2. The method according to claim 1, comprising:
obtaining, by the server, environmental information associated with at least one environment where the first client device and the second client device or avatars corresponding to the first client device and the second client device currently locate;
inputting, by the server, the environmental information to the machine learning model, wherein the machine learning model provide a determination result indicating whether to provide the first position information to the second client device in response to the environmental information.

3. The method according to claim 2, wherein the environmental information comprises device poses of the first client device and the second client device or avatars corresponding to the first client device and the second client device, and configurations of environmental objects within the at least one environment.

4. The method according to claim 1, wherein the machine learning model comprises a reinforcement learning model, and updating the machine learning model according to the feedback message comprises:
in response to determining that the feedback message comprises a negative feedback message, training, by the server, the machine learning model based on the negative feedback message and environmental information associated with at lease one environment where the first client device and the second client device or avatars corresponding to the first client device and the second client device currently locate.

5. The method according to claim 4, wherein updating the machine learning model according to the feedback message further comprises:
in response to determining that the feedback message comprises a positive feedback message, updating, by the server, the machine learning model subject to a behavioural enforcement.

6. The method according to claim 1, further comprising:
receiving, by the second client device, the first position information from the server;
determining, by the second client device, whether the first position information is needed by the second client device and accordingly configuring the feedback message;
sending, by the second client device, the feedback message to the server.

7. The method according to claim 6, further comprising:
in response to determining that the first position information is needed by the second client device, configuring, by the second client device, the feedback message as a positive feedback message;
in response to determining that the first position information is not needed by the second client device, configuring, by the second client device, the feedback message as a negative feedback message.

8. The method according to claim 6, comprising:
determining, by the second client device, whether an avatar corresponding to the first client device is needed to be rendered in a visual content of the second client device based on the first position information;
in response to determining that the avatar corresponding to the first client device is needed to be rendered in the visual content of the second client device, determining, by the second client device, that the first position information is needed by the second client device;
in response to determining that the avatar corresponding to the first client device is not needed to be rendered in the visual content of the second client device, determining, by the second client device, that the first position information is not needed by the second client device.

9. The method according to claim 8, wherein determining, by the second client device, whether the avatar corresponding to the first client device is needed to be rendered in the visual content of the second client device based on the first position information comprises:
performing, by the second client device, a culling algorithm based on the first position information;
in response to determining that a determination result of the culling algorithm indicates that the avatar corresponding to the first client device is not occluded to the second client device, determining, by the second client device, that the avatar corresponding to the first client device is needed to be rendered in the visual content of the second client device;
in response to determining that the determination result of the culling algorithm indicates that the avatar corresponding to the first client device is occluded to the second client device, determining, by the second client device, that the avatar corresponding to the first client device is not needed to be rendered in the visual content of the second client device.

10. The method according to claim 1, further comprising:
in response to determining not to provide the first position information to the second client device, not sending, by the server, the first position information to the second client device.

11. A system for managing position information, comprising:
a server, configured to perform:
receiving first position information from a first client device;
determining whether to provide the first position information to a second client device by using a machine learning model;
in response to determining to provide the first position information to the second client device, sending the first position information to the second client device; and
in response to determining that a feedback message corresponding to the first position information has been received from the second client device, updating the machine learning model according to the feedback message.

12. The system according to claim 1, wherein the server performs:
obtaining environmental information associated with at least one environment where the first client device and the second client device or avatars corresponding to the first client device and the second client device currently locate;
inputting the environmental information to the machine learning model, wherein the machine learning model provide a determination result indicating whether to provide the first position information to the second client device in response to the environmental information.

13. The system according to claim 12, wherein the environmental information comprises device poses of the first client device and the second client device or avatars corresponding to the first client device and the second client device, and configurations of environmental objects within the at least one environment.

14. The system according to claim 11, wherein the machine learning model comprises a reinforcement learning model, and the server performs:
in response to determining that the feedback message comprises a negative feedback message, training the machine learning model based on the negative feedback message and environmental information associated with at least one environment where the first client device and the second client device or avatars corresponding to the first client device and the second client device currently locate.

15. The system according to claim 14, wherein the server further performs:
in response to determining that the feedback message comprises a positive feedback message, updating the machine learning model subject to a behavioural enforcement.

16. The system according to claim 11, further comprising:
the second client device, configured to perform:
receiving the first position information from the server;
determining whether the first position information is needed by the second client device and accordingly configuring the feedback message;
sending the feedback message to the server.

17. The system according to claim 16, wherein the second client device further performs:
in response to determining that the first position information is needed by the second client device, configuring the feedback message as a positive feedback message;
in response to determining that the first position information is not needed by the second client device, configuring the feedback message as a negative feedback message.

18. The system according to claim 16, wherein the second client device performs:
determining whether an avatar corresponding to the first client device is needed to be rendered in a visual content of the second client device based on the first position information;
in response to determining that the avatar corresponding to the first client device is needed to be rendered in the visual content of the second client device, determining that the first position information is needed by the second client device;
in response to determining that the avatar corresponding to the first client device is not needed to be rendered in the visual content of the second client device, determining that the first position information is not needed by the second client device.

19. The system according to claim 16, wherein the second client device performs:
performing a culling algorithm based on the first position information;
in response to determining that a determination result of the culling algorithm indicates that an avatar corresponding to the first client device is not occluded to the second client device, determining that the avatar corresponding to the first client device is needed to be rendered in the visual content of the second client device;
in response to determining that the determination result of the culling algorithm indicates that the avatar corresponding to the first client device is occluded to the second client device, determining that the avatar corresponding to the first client device is not needed to be rendered in the visual content of the second client device.

20. A non-transitory computer readable storage medium, the computer readable storage medium recording an executable computer program, the executable computer program being loaded by a server to perform steps of:
receiving first position information from a first client device;
determining whether to provide the first position information to a second client device by using a machine learning model;
in response to determining to provide the first position information to the second client device, sending the first position information to the second client device; and
in response to determining that a feedback message corresponding to the first position information has been received from the second client device, updating the machine learning model according to the feedback message.
